(19) United States
(12) Patent Application Publication
(10) Pub. No.: US 2026/0003716 A1
(43) Pub. Date: Jan. 1, 2026

(54) Dynamic Generation of User-Facing Error and Status Messages

(71) Applicant: Google LLC, Mountain View, CA (US)

(72) Inventor: Zebedee Pedersen, Hove East Sussex (GB)

(21) Appl. No.: 19/253,190

(22) Filed: Jun. 27, 2025

Related U.S. Application Data
(60) Provisional application No. 63/665,157, filed on Jun. 27, 2024.

(51) Int. Cl. G06F 11/07

(52) U.S. Cl. CPC G06F 11/0784

(57) ABSTRACT

The present disclosure provides computer-implemented methods, systems, and devices for generating natural language error messages. A computing device receives application status data describing an error that occurred during the execution of the computer application. The computing device generates a model input using the application status data. The computing device provides the model input to a machine-learned model. The computing device receives a model output from the generate machine-learned model, the model output including a natural language message to a user to respond to the error described by the application status data. The computing device display the model output to the user.

### PRIORITY CLAIM

The present application is a continuation of U.S. Application No. 63/665,157 having a filing date of Jun. 27, 2024. Applicant claims priority to and the benefit of each of such applications and incorporates all such applications herein by reference in its entirety.

### FIELD

The present disclosure relates generally to generative models. More particularly, the present disclosure relates to producing more useful user facing error and status messages.

### BACKGROUND

Computing systems and the software applications that operate on them are inherently complex, often involving intricate processes and interactions between various system components and external services. When errors occur or the status of these systems becomes compromised, it is important for the systems themselves to efficiently identify, diagnose, and communicate these issues. Traditional error and status messaging mechanisms in computing systems are static, often relying on predetermined error codes and messages that lack context and specificity. This approach can lead to inefficiencies in error resolution, increased system downtime, and challenges in system maintenance.

Therefore, a technical problem is the lack of adaptability and specificity in traditional error and status messaging mechanisms within computing systems. These traditional mechanisms do not account for the dynamic nature of computing environments where errors and statuses can be influenced by a variety of ever-changing factors, such as system configuration, user interactions, and external system dependencies. This limitation hampers the ability of computing systems to promptly and accurately identify the root causes of issues and to provide actionable and context-specific guidance for resolution, resulting in increased system downtime and reduced computational efficacy and efficiency.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can be performed by a computing system comprising one or more processers. The method comprises receiving, by a computing system as part of the execution of a computer application, application status data describing an error that occurred during the execution of the computer application. The method further comprises generating, by the computing system, a model input using the application status data. The method further comprises providing, by the computing system, the model input to a machine-learned model. The method further comprises receiving, by the computing system, a model output from the generate machine-learned model, the model output including a natural language message to a user to respond to the error described by the application status data. The method further comprises displaying, by the computing system, the model output to the user.

Another example aspect of the present disclosure is directed to a computing device. The computing device comprises one or more processors and a computer-readable memory, wherein the computer-readable memory stores instructions that, when executed by the one or more processors, cause the computing device to perform operations comprising receiving, by a computing system as part of the execution of a computer application, application status data describing an error that occurred during the execution of the computer application. The operations further comprise generating, by the computing system, a model input using the application status data. The operations further comprise providing, by the computing system, the model input to a machine-learned model. The operations further comprise receiving, by the computing system, a model output from the generate machine-learned model, the model output including a natural language message to a user to respond to the error described by the application status data. The operations further comprise displaying, by the computing system, the model output to the user.

Another example aspect of the present disclosure is directed towards a non-transitory computer-readable medium storing instructions that, when executed by one or more computing devices, cause the one or more computing devices to perform operations comprising receiving, by a computing system as part of the execution of a computer application, application status data describing an error that occurred during the execution of the computer application. The operations further comprise generating, by the computing system, a model input using the application status data. The operations further comprise providing, by the computing system, the model input to a machine-learned model. The operations further comprise receiving, by the computing system, a model output from the generate machine-learned model, the model output including a natural language message to a user to respond to the error described by the application status data. The operations further comprise displaying, by the computing system, the model output to the user.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system according to example embodiments of the present disclosure;

FIG. 2 depicts a flow diagram of an example process for generating natural language error and status messages according to example embodiments of the present disclosure;

FIG. 3 is an example method for generating user messages in natural language in accordance with embodiments in accordance with example embodiments;

FIG. 4 depicts an example computing system in accordance with example embodiments of the present disclosure.

FIG. 5 depicts an example client-server environment according to example embodiments of the present disclosure;

FIG. 6 depicts a flow chart diagram of an example method according to example embodiments of the present disclosure;

FIG. 7 is a block diagram of an example processing flow for using machine-learned model(s) to process input(s) 2 to generate output(s) according to example embodiments of the present disclosure;

FIG. 8 is a block diagram of an example implementation of an example machine-learned model configured to process sequences of information according to example embodiments of the present disclosure;

FIG. 9 is a block diagram of an example technique for populating an example input sequence according to example embodiments of the present disclosure;

FIG. 10 is a block diagram of an example computing device according to example embodiments of the present disclosure; and

FIG. 11 is a block diagram of an example computing device according to example embodiments of the present disclosure.

Reference numerals that are repeated across plural figures are intended to identify the same features in various implementations.

### DETAILED DESCRIPTION

Generally, the present disclosure is directed to a system that provides status and error messages to a user in natural language so that the error messages can be more easily understood and reacted to. In particular, complicated computing systems and applications can be challenging for users to understand adequately. Furthermore, complicated computing systems and applications can rely on a large number of varied factors to operate correctly. As a result, if an error or other issue occurs, it has traditionally been difficult for the system to generate a message that properly informs users of the particular problem and enable them to resolve the issue. This issue is further complicated when novel application architectures that are made possible by AI software is introduced. For example, novel software architectures can include in tool-operation applications, applications developed around chaining architectures, or in modular application architectures where feature responses are derived from multiple programmatic modules.

When a user (or operator) of a computing system interacts with an application, they can typically request that the application perform one or more operations (e.g., saving or loading a file, accessing a resource, displaying certain information and so on). Each requested operation can have an associated set of success, failure, status, and error messages or data. According to an aspect of the present disclosure, in response to this challenge, a computing system or application can use a generative model to generate natural language explanations of the various success, failure, status, and error messages status or error messages that describe the current status or error associated with a computing system or a computer application.

For example, when a computing system or application determines that a status or error message needs to be delivered to the user, the system or application can generate status data. The status data can be an error code or other error message. The error code can be expressed as a machine code or in a machine language that is not a natural language. The computing system can use this status data to generate a prompt to the generative model (e.g., a sequence processing model). The prompt can include the status data from the computing system or a computer application. In some examples, the prompt can also include contextual data and instructions to the generative model describing the type of output to be produced.

The generative model can produce a model output based on the model input. The model output can be a natural language explanation of a current status or error issue associated with the computing system and information on possible resolutions if a resolution is needed. The model output can be presented to the user. In some examples, the status data can be an explanation of a current status or error, as well as a series of instructions to resolve the situation. The model output can be presented to the user, and the user can take whatever steps they deem necessary based on the natural language message.

For example, a user can use an email application to draft an email on their mobile computing device. Once the user is prepared to send the email, the user can select the send button in the user interface. Doing so triggers a request to an email service to send a message the user has drafted. If the mobile computing device has lost its wireless connection to the Internet, the operation will fail. static error message might report “Message Send Failure” to the user, leaving the user to determine the cause of (and therefore the solution to) the issue. Using the dynamic error messaging system, the application is able to report “Your phone lost signal while sending the message. Make sure you have internet access before re-sending.” based on the status data provided to it by the application developer (or gathered by the message generation system). The user can use this message to enable them to determine the problem and resolve it. In this example, the user can ensure the internet connectivity has been restored before trying to send the email.

The sequence processing model can be trained using existing examples of status data (e.g., error data and other information) that has been produced by applications and stored in logs along with explanations of that status data in natural language. In some examples, the training data can include a relatively small number of manually generated examples. In other examples, the training data can include data from web logs of errors and solutions. In some examples, written correspondence included in help tickets could be converted into training pairs. In some examples, a relatively large number of automatically generated examples can also be used to supplement the trained data set.

The systems and methods of the present disclosure provide a number of technical effects and benefits. As one example, the systems and methods can provide a dedicated pipeline for natural language messages with respect to errors or status changes associated with the operations of computer applications. Doing so can result in improved computational efficiency and improvements in the functioning of a computing system. For example, the systems and methods disclosed herein can leverage the machine-learned model to provide useful and easily understood instructions for enabling a user to respond to an error or status with minimal cost.

Thus, the present disclosure significantly enhances the diagnostic capabilities of computing systems by dynamically generating context-aware error and status messages using generative models. Unlike traditional static messaging systems that provide generic or vague messages, this innovation processes real-time data and system-specific context to produce precise and actionable messages tailored to the specific error or status. This precision in diagnostics helps quickly identify the root causes of issues, reducing the time and resources spent on troubleshooting and thereby improving the overall efficiency and reliability of the computing system operations.

By providing detailed and context-specific error messages, the system outlined in the present disclosure aids in faster resolution of issues, directly contributing to reducing system downtime. The actionable insights offered by the dynamically generated messages enable system administrators and users to address and resolve errors without the need for extensive manual intervention. This not only speeds up recovery times but also significantly lowers maintenance overheads as the system provides clear guidance on the steps to resolve issues, minimizing the need for trial-and-error approaches and extensive technical support.

Finally, the disclosed system's ability to incorporate real-time data and adapt its messaging based on the current system status and external factors introduces a high degree of flexibility and adaptability. This is particularly beneficial in modern computing environments that are highly dynamic and subject to frequent changes in configuration, user interactions, and external dependencies.

With reference now to the Figures, example embodiments of the present disclosure will be discussed in further detail.

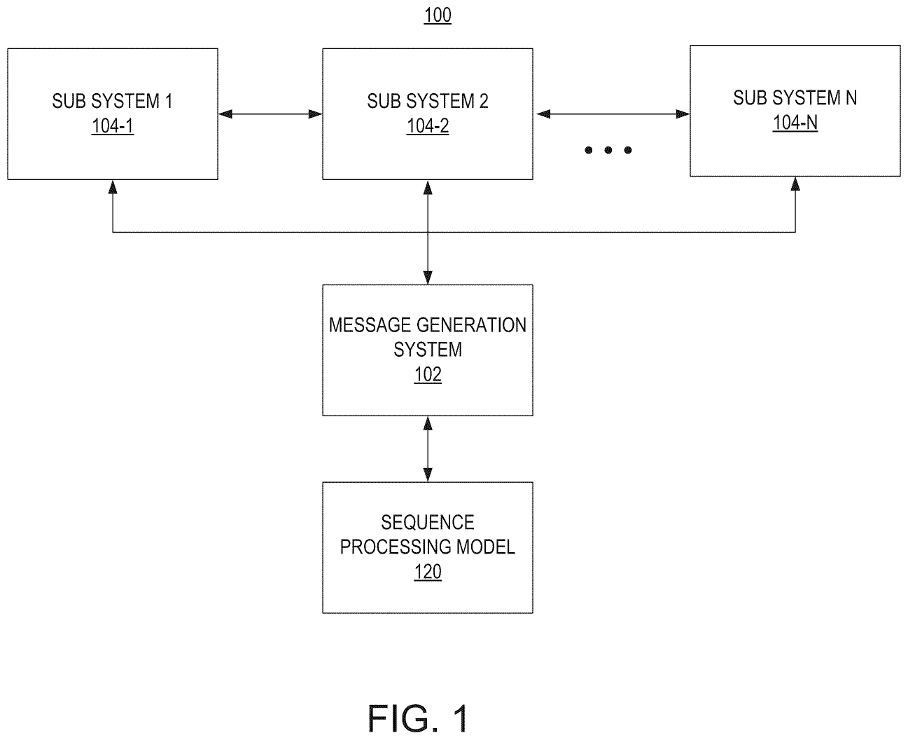

FIG. 1 depicts a block diagram of an example computing system 100 according to example embodiments of the present disclosure. In some implementations, the computing system 100 includes a plurality of computing sub-systems (e.g., sub-system 1 104-1, sub-system 2 104-2, and sub-system N 104-N), a message generation system 102, and a sequence processing model 120. The computing system 100 can include elements or sub-systems not displayed in the figure. In some examples, the various sub-systems can communicate directly with one another and with the sequence processing model 120. The figure depicts the computing system 100 as a single computing system, but the various elements of the computing system can be spread across a plurality of computing systems that are communicatively coupled (e.g., via a computing network).

In some examples, the sub-systems (e.g., 104-1 to 104-N) can include systems that provide a variety of functions. In some examples, each sub-system (any one of 104-1 to 104-N) can communicate with the message generation system 102 when an error occurs or when a status is updated. In some examples, the sub-system (any one of 104-1 to 104-N) can provide error or status data to the message generation system 102. In some examples, the status data can include an error code predetermined by the programming of the sub-system. In other examples, the status data can include information generated by the respective sub-system about the error and or the status change that is programmatically determined to be useful in explaining the current error to a user.

The message generation system 102 can receive error and/or status data from one or more respective sub-systems, provide that status data, along with other contextual information, to sequence processing model 120 (e.g., a generative model), and provide the output of the model to a user for display. In some examples, the message generation system 102 can determine when a message is necessary. For example, a respective sub-system can transmit an error notification to the message generation system 102. In response, the message generation system 102 can generate a prompt to the sequence processing model 120. The prompt can include information describing the current error, including but not limited to an error code or other information describing the error, contextual information about the user, contextual information about the current status of the system, information received from other sub-systems about the status of the system, and information retrieved from databases about potential errors and/or statuses.

In some examples, the message generation system 102 can generate a search query based on the status data to search a contextual data database. The data retrieved from the database in response to the search query can be provided as context in the prompt. In some examples, the prompt can include additional instructions indicating the type of output desired. For example, the prompt can instruct the sequence processing model 120 to provide a natural language explanation of the status and/or error.

The sequence processing model 120 can be trained to receive a prompt from the message generation system 102. The sequence processing model 120 can be a machine-learned model trained to generate natural language explanations of particular errors or status situations. The sequence processing model 120 can receive a prompt, process that prompt, and output a model output. The model output can be a natural explanation of the issue (e.g., the error or status change) associated with one of the sub-systems or with a particular application.

In some examples, the model output can be an explanation of the error or the status. In some examples, the explanation can include a series of suggested steps the user can take to resolve the issue. The recommended steps can include links to additional information to instruct the user on resolving potential problems.

Once the sequence processing model 120 has generated an output, the message generation system 102 can transmit the explanation to a user. In some examples, the explanation can be displayed to the user in a user interface associated with a particular application. In one example, the application can be configured to display the explanation within the user interface of the application. In other examples, the explanation can be displayed in the operating system's user interface but not in the application's user interface.

In one specific example, the computing system 100 can include an internet browser application which is built around generative AI. The internet browser application can provide an omnipresent “talk bar” with which its user can talk to anything they are looking at by entering queries about the displayed content into the talk bar (for example, a web page, or an image on a web page).

If a webpage displays the timetable of an event, the user can enter a question such as “Will I be able to go to this event?” into the “talk bar.” In response to such a question, the internet browser application (e.g., sub-system 104-1) can access other sub-systems to access relevant information relevant to the query. This information can be provided to a generative model as context when generating an answer to the user's query. For example, the internet browser application (e.g., sub-system 104-1) may access an email sub-system (e.g., 104-2), a web search sub-system (not pictured), and a browser history subsystem (e.g., 104-N) to access data that can be used to accurately answer the user's query.

Assuming, in this example, that the web search and browsing history sub-systems have reported the requested content but the email sub-system (e.g., 104-2) has was unavailable due to a service outage, a traditional error reporting system may display the error message “500 Internal Server” to a user. This may be difficult for the user to understand.

The technology described in this disclosure can allow the internet browser application (e.g., sub-system 104-1) to report the error in plain language such as “There was an error reaching the Gmail service, it looks like there is a server issue.” In some examples, this message may not be reported directly to a user. instead, the internet browser application (e.g., sub-system 104-1) can provide context when responding to the user's query such as “There aren't any conflicts with this event from your browsing history, however I was unable to reach your Gmail to check for conflicts-you can try asking again shortly.” In this way, the user can clearly understand the issue and knows what steps to take if they wish to do so.

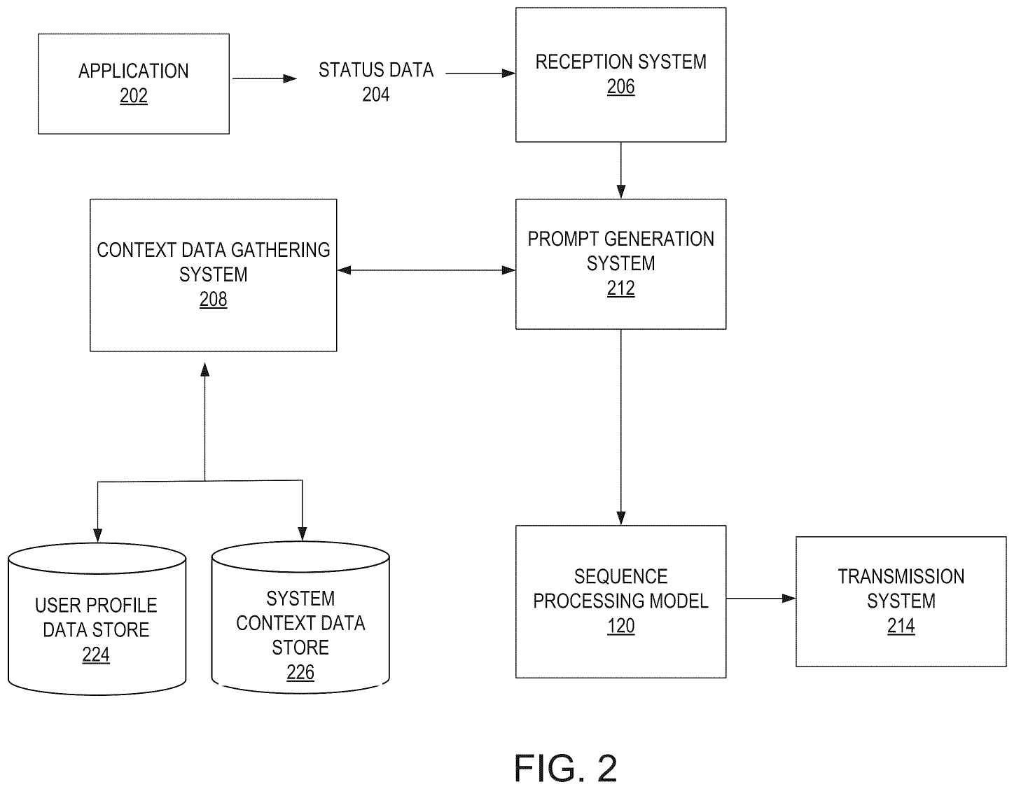

FIG. 2 depicts a flow diagram of an example process for generating natural language error and status messages according to example embodiments of the present disclosure. In this example, an application 202 can generate status data 204. The status data can include information associated with an error that has occurred or a change in status associated with the computing system or the computer application. The application can be any application executable by a computing system, such as search applications, communication applications, navigation applications, productivity applications, game applications, word processing applications, or any other applications. In some examples, the application 202 can be a more general system application, such as an operating system.

In some examples, status data 204 includes error data about application 202. In some examples, when an error occurs in application 202, the application itself may generate data describing the error that occurred. In some examples, the error data can include a predetermined error code. In other examples, the data output by application 202 in response to the error may be data intended to be received by the reception system 206.

The reception system 206 can receive status data 204 from the application 202 (or the system itself). The reception system 206 can analyze the status data 204 to determine whether the user needs to be notified about the issue described in the status data 204. In some examples, the status data 204 can be minor and may not be helpful to display to the user. The computing system can use the status data internally in an automated fashion and as such the status data 204 may not be intended to be displayed to the user. Suppose the reception system 206 determines that the user does not need to be notified of the status data 204. In that case, the reception system 206 may store a record of the status data 204 in a log or may take other steps to alleviate the issue indicated by the status data 204.

Applications can be customized to output data to be used for generating a natural language error report. However, existing applications that have not been customized to create such useful data can still benefit from the system based on the status data they produce. In some examples, the status data 204 includes information about a status change in the application or the general system. For instance, if an application 202 has finished downloading a file or performing another task, the application 202 can output information describing the change in status. Similarly, if the status of the entire system changes in some way, such as being disconnected from its Internet connection, that information can be provided to the reception system 206 as status data 204.

The reception system 206 can also determine that the status data 204 should be presented to the user to explain a particular error or status. In this case, the reception system 206 can transmit the received status data 204 to the prompt generation system 212. The prompt generation system 212 can generate a prompt to a sequence processing model 120. A prompt can include instructions that the sequence processing model 120 uses to generate an output. For example, the prompt can consist of the status data 204 along with a request that the sequence processing model 120 generate a natural language explanation of the error data for a user. In some examples, the prompt can include contextual data that enables the sequence processing model 120 to provide a more complete and useful response. The contextual data can be received from a context data gathering system 208.

The context data gathering system 208 can access information about the user and the status data 204 to provide additional context for the prompt. The context data gathering system 208 can use user data associated with the application 202 to access a user profile stored in the user profile data store 224. The user profile data store 224 can include information about the user's current proficiency, past experiences, and interactions between the user and the message generation system 102. For example, if the user has previously encountered this error or status change, information from the user profile data store 224 can be used to consider that situation when generating the current response. For example, if the user had previously received an explanation of an error but could not successfully resolve it, that information can be included in the prompt by the prompt generation system 212.

In some examples, the user profile data store 224 can include information about the user's demographic information (e.g., age, location, and so on). This information can be used to determine the language of the response, the level of expertise required to understand the response, information about the resources the user has access to (e.g., whether the user has performed an online search), the user's age, the user's past ability to resolve issues based on the feedback, and so on. This information can be requested by the context data gathering system 208 and provided by the user profile data store 224.

The system context data store 226 can store any information about the larger computer system, application 202 and its history of errors and status messages, factual information that may be available via a search of a general knowledge database, and information about previous errors with application 202. For example, the computing system has information about its connections to other computing systems, the components available to the computing system, its ability to connect to the Internet, previous errors and statuses, and other information that may be useful when seeking to understand an error that has occurred or status that has changed. The context data gathering system 208 can use a query to retrieve information pertinent to a particular status data and use the query to retrieve relevant data from the system context data store 226. It should be noted that the system context data store 226 is represented as a single database but may, in fact, be a plurality of different databases, some available locally and some available over a network connection. Data retrieved in response to a query generated by the context data gathering system 208 can be returned by the system context data store 226 and provided to the prompt generation system 212 for inclusion in the prompt.

The system context data store 226 can also include data about the application 202. For example, the system context data store 226 can include data about the operation of the application 202, including frequently encountered errors and how to resolve them, advice on what errors are likely to be expected and what likely causes are, information about the status, and other information. In some examples, the system context data store 226 includes a record of previous users' experience with the application 202 and errors they have encountered. For example, a portion of the system context data store 226 can be stored at a third-party server and be searchable via web request. The context data gathering system 208 can generate a search query that retrieves contextual information from the system context data store 226 if this context is determined to be required.

The context data gathering system 208 can provide the context data received from the user profile data store 224, and the system context data store 226 to the prompt generation system 212. The prompt generation system 212 can include the contextual data in the prompt. The prompt can also include information describing the requested length of the output of the sequence processing model 120. For example, the prompt generation system 212 can determine the amount of space the user interface has to display this message and include those instructions in the prompt so the sequence processing model 120 can provide an output that meets the space requirements. The prompt can be provided to the sequence processing model 120, and the sequence processing model 120 can provide a model output.

The model output can be a natural language explanation of the error (or the status change) represented in the status data 204. In some examples, the output can include an explanation to the user describing the issue (e.g., an error or a status change) at a level appropriate for the user's level of understanding. For example, beginner users may have a more descriptive explanation that contains explanations of basic concepts and overall includes more details, while an expert user may have a shorter and less explanatory message.

In some examples, the model output can include suggestions for resolving errors. For example, the sequence processing model 120 can use data it has been trained on or data supplied in the prompt to determine one or more steps the user can take to resolve an error or deal with the change in status. These steps can be provided to the user in the output. In some examples, the user can give feedback to the model's response (e.g., to ask questions or receive additional clarifications). If so, the sequence processing model 120 can provide a response to the feedback. In this way, the user can work to resolve any issue by repeatedly asking follow-up or clarification questions.

The model output from the sequence processing model 120 can be provided to the transmission system 214. The transmission system 214 can transmit the model output to the user. The transmission system 214 can display the response to the user in the interface of the application itself. In some examples, the sequence processing model 120 is operated at a service remote from the user computing system, and the transmission system 214 transmits the model output via a network to the user computing device for display.

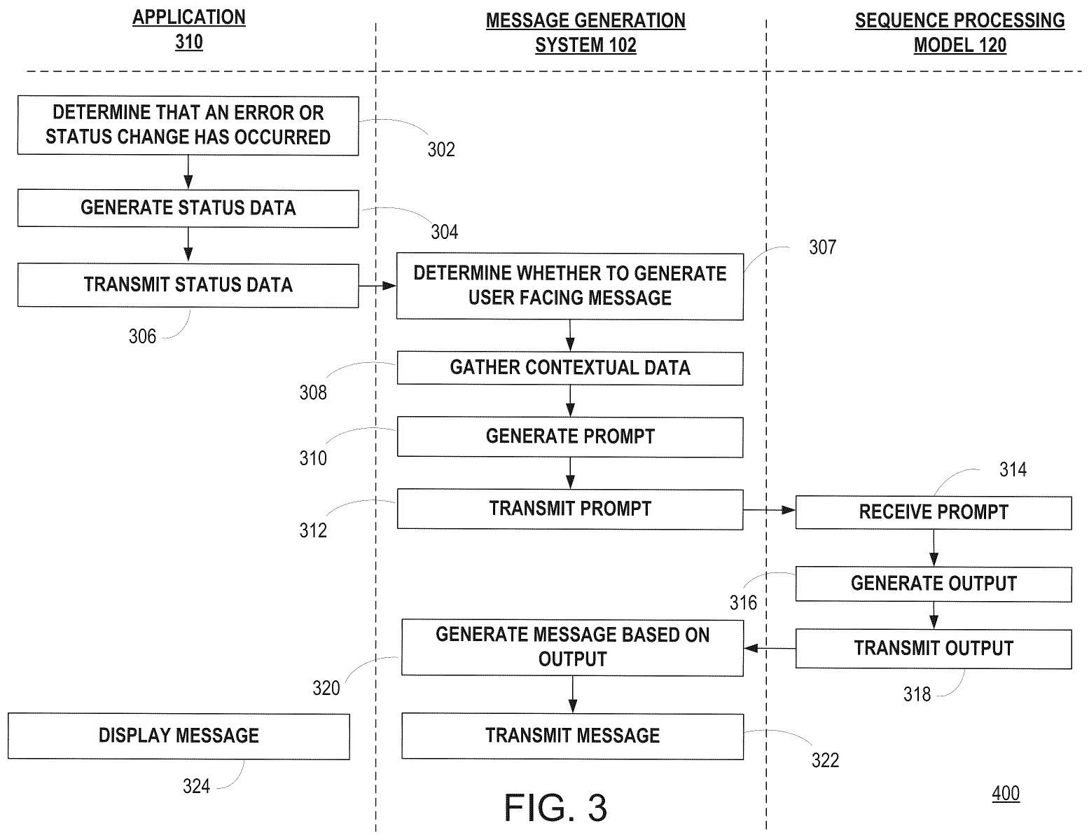

FIG. 3 is an example method for generating user messages in natural language according to example embodiments of the present disclosure. In this example, application 310 can be executed on a user computing device. The application 310 can perform a plurality of different functionalities. In some examples, an error can occur with one the application 310, or the status of something in the system can change based on the operations of the application 310. Based on the error or change of status, the application 310 can generate status data at 304.

It should be noted that status data can include error codes produced by the application that are hard coded into the application's instructions. In other examples, the status data can include information describing a change of status without any particular error. In other examples, the status data can include information provided by the application 310 that generally describes a problem or error that has occurred without a particular hard-coded error code. For example, if the application has been specifically designed to work with the message generation system 102, the error data can include helpful information for the messaging system, such as context associated with the error or status change.

Once the application has generated the status data at 304, the application can transmit the status data at 306. In some examples, the status data is transmitted within the same computing system. In other examples, the status data can be transmitted to a different computing system where the message generation system 102 is stored. In yet other examples, message generation system 102 can be provided by a remote server system. In this example, the application can use computing networks to communicate the status data to the message generation system 102.

In some examples, the message generation system 102 can receive the status data. Once the message generation system 102 has received the status data, the message generation system 102 can determine whether to generate a user-facing message at 307. For example, some status data may be associated with errors that need to be brought to the user's attention, while other errors may be errors that are primarily of interest to the system itself and do not need to be surfaced to the user. Instead, the error data can be provided to another system within the computer system or stored in a log for use if further analysis is required. If the message generation system 102 determines that no user-facing message is needed, the message generation system 102 can use the status data as determined based on criteria at the messaging system 102. Potential uses include providing it to another computing system, sub-system, or application or storing it in a log.

If the message generation system 102 determines, at 307, that the status data should be used to generate a user-facing message, the message generation system 102 can, at 308, generate contextual data for the status data. As mentioned above, contextual data can include data describing the user, the user's capabilities, other attributes of the system, and information about the application 310 itself. In some examples, the message generation system 102 can use a query to access information about past errors that have occurred with the application 310. For example, the messaging system can search a database of information describing previous user experiences with errors and how those errors were resolved.

Once the message generation system 102 has accessed the contextual data, the message generation system 102 can use the status data and any associated contextual data to generate a prompt to the sequence processing model 120. The prompt can include information describing the error data, the contextual data, and any instructions that the message generation system 102 uses to ensure that the output of the sequence processing model 120 is appropriate. For example, the instructions can include information describing the length or format of the answer. Once the prompt has been generated, the message generation system 102 can, at 312, transmit the prompt to the sequence processing model 120.

As noted above, the sequence processing model 120 can be located at the user computing device, a communicatively coupled device, or a remote server system from the user device at which the application 310 is executing. Thus, transmitting the prompt can include communicating using the computer's internal communication method, communicating over a near-field communication method, or transmitting the prompt over a computing network to a remote server system. In some examples, the sequence processing model 120 is executed on the user computing device. Running the model locally can reduce the need to sends large amounts of data (e.g., full logs or the application state) via computing network, which reduces bandwidth usage and transmission time. In addition, this can ensure user privacy of the materials in the logs.

The sequence processing model 120 can receive the prompt at 314. The sequence processing model 120 can, at 316, generate an output based on the prompt. The output can be a natural language response to the error data, giving the user information about an error or status change using terminology and information the user can understand.

The sequence processing model 120 can, at 318, transmit the output to the message generation system 102. The message generation system 102 can, at 320, generate a message for the user based on the output at 320. In some examples, the message generation system 102 can format the appearance of the message or extract a particular piece of the output for display to the user. The message generation system 102 can, at 322, transmit the message to the user's computing device. The application 310 can receive the message from the message generation system 102 and, at 324, display the message to the user. In some examples, the message can be displayed within the user interface of the application 310. In other examples, the message can be displayed in the operating system's user interface but not within that of the application itself 310.

For example, if the application 310 is an on-line document service, which allows users to create, edit, and share on-line documents, users can choose to perform operations through the application 310. In this example, user A edits a spreadsheet and attempts to share it with user B. The system determines that the user is not permitted to receive that spreadsheet based on the policy of the organization of user A. A static error message may read “Unable to share with user B.” Such a message provides little detail that would allow user A to identify the specific problem and correct it.

Using the disclosed technology, the application 310 can generate status data representing the error (User A was prohibited from sharing the spreadsheet with User B due to organizational policy). This data can be transmitted to the message generation system 102. The message generation system 102 can determine that the user should be made aware of the issue (at 307), gather contextual information (at 308 including the organizational policies), and generate a prompt for the sequence processing model 120. The sequence processing model 120 can dynamically generate a message based on the context such as “Organizational policy only allows sharing within the organization. Because user B is outside the organization, you can't share with him. You can apply for an exception with your manager.”

Such a message clearly identifies the problem and the steps the user can take to resolve the issue. For a different user, the message generation system 102 can include different information, including, for example, a link to the organizational policy document.

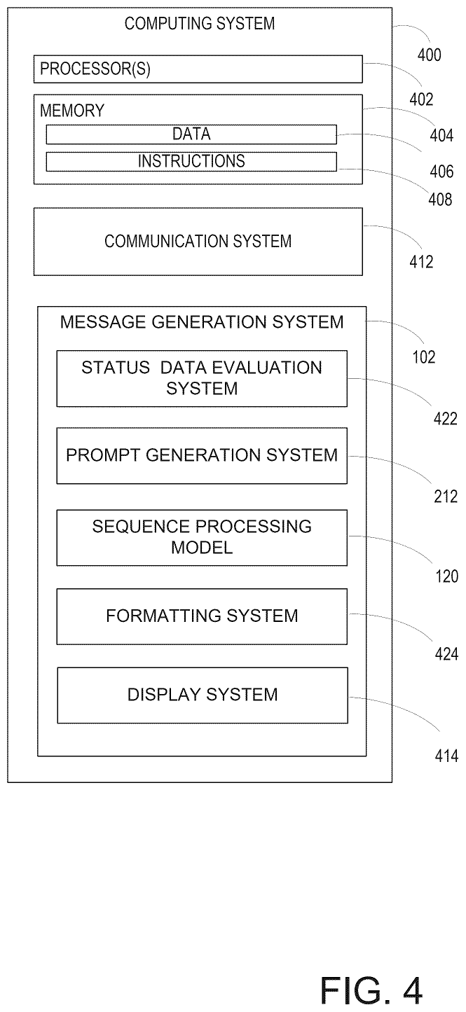

FIG. 4 depicts an example computing system 400 in accordance with example embodiments of the present disclosure. In some example embodiments, the computing system 400 can be any suitable device, including, but not limited to, a personal computer, a laptop computer, a workstation computer, or any other computing system that is configured such that it can receive communications via a computer network and transmit communications to the other computing systems via the network. The computing system 400 can include one or more processor(s) 402, memory 404, a communication system 412, and a message generation system 102.

The one or more processor(s) 402 can be any suitable processing device, such as a microprocessor, microcontroller, integrated circuit, or another suitable processing device. The memory 404 can include any suitable computing system or media, including, but not limited to, non-transitory computer-readable media, RAM, ROM, hard drives, flash drives, or other memory devices. The memory 404 can store information accessible by the one or more processor(s) 402, including instructions 408 that can be executed by the one or more processor(s) 402. The instructions can be any set of instructions that, when executed by the one or more processor(s) 402, cause the one or more processor(s) 402 to provide the desired functionality.

In particular, in some devices, memory 404 can store instructions for implementing the communication system 412 and the message generation system 102. The computing system 400 can implement the communication system 412 and the message generation system 102 to execute aspects of the present disclosure, including determining whether a particular application includes one or more third-party libraries.

It will be appreciated that the terms “system” or “engine” can refer to specialized hardware, computer logic that executes on a more general processor, or some combination thereof. Thus, a system or engine can be implemented in hardware, application-specific circuits, firmware, and/or software controlling a general-purpose processor. In one embodiment, the systems can be implemented as program code files stored on a storage device, loaded into memory, and executed by a processor or can be provided from computer program products, for example, computer-executable instructions, that are stored in a tangible computer-readable storage medium such as RAM, hard disk, or optical or magnetic media.

Memory 404 can also include instructions 408 and data 406, such as applications and software signatures available to the message generation system 102, that can be retrieved, manipulated, created, or stored by the one or more processor(s) 402. As noted above, the computing system 400 includes a communication system 412, the message generation system 102, and other system components not pictured in FIG. 4. The communication system 412 can receive communications from remote computing systems over a communication network. The communications can include, for example, a request from a user computing device to generate a natural language explanation of an error that has occurred and provide recommended steps for resolving the error. For example, a user can download a large file on their smartphone. The disk storage system of the smartphone can determine that the amount of space remaining is less than a threshold amount. The smartphone can generate a request that the message generation system 102 create a natural language message explaining the issue and include information on how the issue may be resolved based on the user's profile. For example, the generated message can be ““You have very little storage remaining—there are a lot of files in your downloads folder which haven't been accessed in a long time which might be a good place to start freeing up space.”

In some examples, the communication system 412 can transmit requests or receive responses from a remote server system providing access to the application (or application data). In this example, the message generation system 102 can access a sequence processing model provided by a remote server system. The communication system 412 can receive a response that includes the output of that model.

The message generation system 102 can include a status data evaluation system 422, a prompt generation system 212, a sequence processing model 120, a formatting system 424, and a display system 414.

The message generation system 102 can receive status data from an application or a system and dynamically generate a customized user message that describes the error or status change to the user in natural language. To do so, the message generation system 102 can receive the status data and provide it to the status data evaluation system 422. The status data evaluation system 422 can determine whether to provide a message to the user based on the status data. As discussed above, the determination of whether to provide a message to the user can be based on whether the status data includes information that the user needs to resolve an issue. For example, some data provided in the status data can include information intended for another portion of the system, not the user.

In other examples, the status data can include information describing an error that has occurred with an application or the system of which the user should be apprised. If the status data evaluation system from 422 determines that the application status data includes information that should be provided to the user, the status data evaluation system 422 can provide that status data to the prompt generation system 212.

The prompt generation system 212 can generate a prompt for a machine-learned model. The prompt can include the status data, contextual information about the user and/or the application from which the application status data has been received, information about the type of message requested, and so on. The prompt generation system 212 can provide the prompt to the sequence processing model 120.

In some examples, the sequence processing model 120 can use the prompt to generate an output. The model output can include a natural language response explaining the particular issue that has occurred or the status that has changed. The model output can include a response dynamically customized to the user's current understanding and the context of the system. In some examples, the model output can be screened for errors or hallucinations.

The model output can be provided to the formatting system 424. The formatting system 424 can format the model output such that it is prepared to be displayed to the user in the user interface of the computing system. In some examples, formatting can include changing the size or length of the data, determining the space available to display the message, editing the response as needed, and determining when and where to display the response.

The display system 414 can update the user interface to include the generated response. In some examples, the response can be displayed as part of the user interface of the application in which the error occurred. In other examples, the display system 414 can display the generated response in a portion of the user interface of the operating system but not of the particular application in which the error occurred.

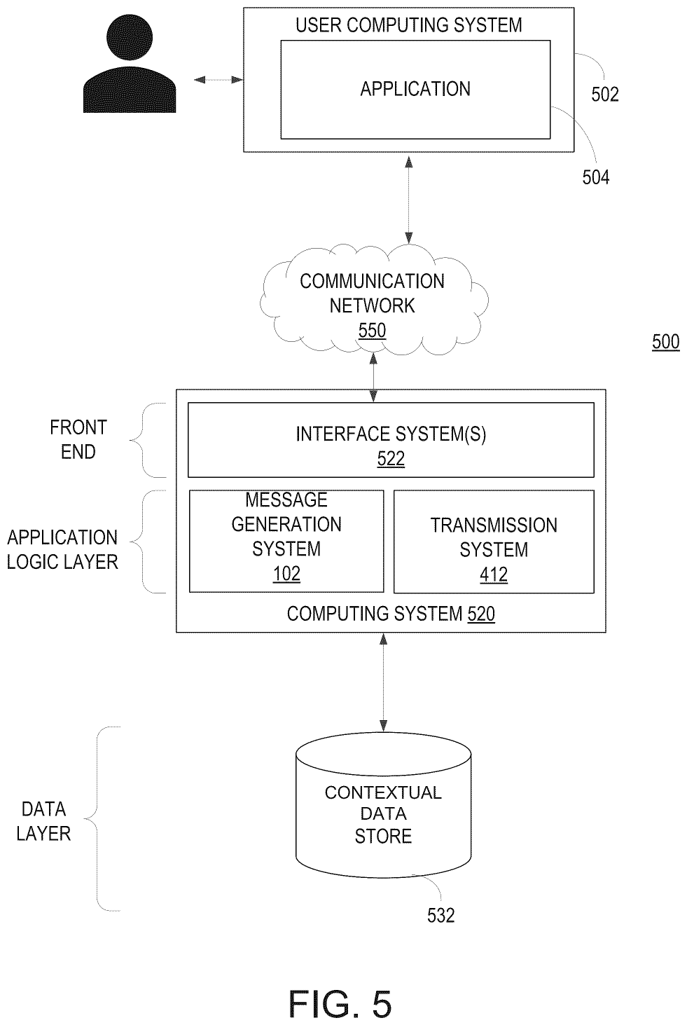

FIG. 5 depicts an example client-server environment 500 according to example embodiments of the present disclosure. The client-server system environment 500 includes one or more user computing systems 502 and a computing system 520. One or more communication networks 550 can interconnect these components. The one or more communication networks 550 may be any of a variety of network types, including local area networks (LANs), wide area networks (WANs), wireless networks, wired networks, the Internet, personal area networks (PANs), or a combination of such networks.

A user computing system 502 can be one of, but is not limited to, a personal computing system, a smartphone, a smartwatch, a laptop computing device, and a tablet computing system. In some examples, the user computing system 502 can include one or more application(s) 504, such as search applications, communication applications, navigation applications, productivity applications, game applications, word processing applications, or any other applications. The application(s) can include a web browser. The user computing system 502 can use a web browser (or other application) to send and receive requests to and from the computing system 520. The user computing system 502 can request that the computing system 520 provide a natural language message for a particular error or change in status. The computing system 520 can generate and transmit a message to the user computing system 502.

As shown in FIG. 5, the computing system 520 can generally be based on a three-tiered architecture, consisting of a front-end layer, application logic layer, and data layer. As is understood by skilled artisans in the relevant computer and Internet-related arts, each component shown in FIG. 5 can represent a set of executable software instructions and the corresponding hardware (e.g., memory and processor) for executing the instructions. To avoid unnecessary detail, various components and engines that are not germane to conveying an understanding of the various examples have been omitted from FIG. 5. However, a skilled artisan will readily recognize that various additional components, systems, and applications may be used with a computing system 520, such as that illustrated in FIG. 5, to facilitate additional functionality that is not specifically described herein. Furthermore, the various components depicted in FIG. 5 may reside on a single server computer or may be distributed across several server computers in various arrangements. Moreover, although computing system 520 is depicted in FIG. 5 as having a three-tiered architecture, the various examples of embodiments are not limited to this architecture.

As shown in FIG. 5, the front end can consist of an interface system(s) 522, which receives communications from one or more user computing system 502 and communicates appropriate responses to the user computing system 502. For example, the interface system(s) 522 may receive requests in the form of Hypertext Transfer Protocol (HTTP) requests, or other web-based application programming interface (API) requests. The user computing system 502 may be executing conventional web browser applications or applications developed for a specific platform to include any of a wide variety of computing devices and operating systems.

As shown in FIG. 5, the data layer can include a contextual data store 532. The contextual data store 532 can include information describing that user, the user's current level of understanding, demographic information about the user, and so on. In addition, the contextual data store 532 may store data about particular applications and errors that are likely to occur in those applications. In addition, the contextual data store 532 can include previous instances in which errors occurred and the specific actions taken by users or the message generation system 102 to resolve those errors or status changes.

The contextual data store 532 can include information that can be useful when generating a message that describes a particular error or status change. In some examples, the contextual data store 532 includes a searchable database of factual information about particular applications and previous error solutions that have been used or generated. This way, the computing system 520 can access this contextual data store information to generate a more useful and appropriate response or message for a particular error or status change.

The application logic layer can include application data that can provide a broad range of other applications and services that allow users to request dynamically generated user messages. The application logic layer can include a message generation system 102 and a transmission system 518.

When a user computing system 502 transmits a request to the computing system 520 to provide a message explaining a particular error or status change based on status data generated by the application 504. The message generation system 102 can receive status data (which can include both data associated with a particular error and data associated with a status change or other happening generally). In some examples, the status data can include all their contextual data, including the application that has generated the error data and information about the particular user (e.g., user profile).

The message generation system 102 can generate a prompt to a machine-learned model based on the status data received from the user computing system 502. The status data can include error data or other information describing the error or status change at the user computing device. In some examples, the message generation system 102 can access data from the contextual data store 532 to supplement the information the user computing system 502 provides. This information can be included in a prompt. Once the prompt has been generated, it can be supplied to a machine-learned model (e.g., generative model or sequence processing model). The machine-learned model (a generative model or other model) can generate a model output based on the prompt.

The output from the sequence processing model can be a response to the prompt. In some examples, the output can include a message for display to the user explaining a particular error or status change in natural language terms the user can understand. In some examples, the output can be formatted based on information, including the prompt. In some examples, the generative model or other machine learning model can provide output with a particular length or other characteristics such that it is more easily displayed to the user at the user computing system 502.

Once the message generation system 300 has received the model from the machine learning model (e.g., generative model or sequence processing model), the message generation system 102 can provide it to the transmission system 518. The transmission system 518 can transmit the generated message to the user computing system 502 for display to the user.

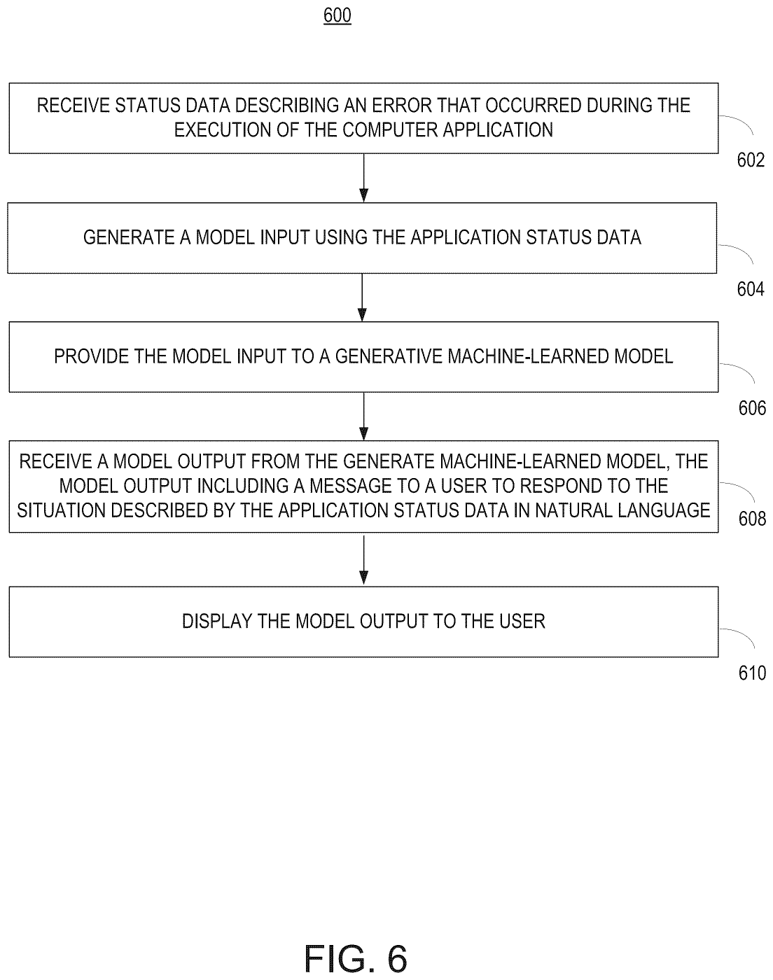

FIG. 6 depicts a flow chart diagram of an example method to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

The computing system can, at 602, receive status data describing an error that occurred during the execution of the computer application. In some examples, the status data includes an error code. In some examples, the error code is a fixed value the computer's creator predetermined when the computer application was created. The status data can describe a type of error and the context of the error.

The computing system can, at 604, generate a model input using the status data. The model input can be a prompt. The prompt can include the status data and contextual data associated with the operation of the computer system or a specific application. The contextual data includes user profile data describing the current level of understanding associated with the user.

In some examples, the contextual data includes information describing the current operational status of one or more components of the computing system executing the computing application. Based on the application status data, the computing system can determine one or more sources of data associated with the error that occurred during the execution of the computing application. The computing system can access contextual data from the one or more determined sources of data. The computing system can add the contextual data to the model input.

In some examples, the computing system can, at 606, provide the model input to a machine-learned model. The machine-learned model can be a generative model. The machine-learned model can also be a sequence processing model.

The computing system can, at 608, receive a model output from the generative machine-learned model, the model output including a message to a user to respond to the issue described by the application status data in natural language. The computing system can, at 610, display the model output to the user.

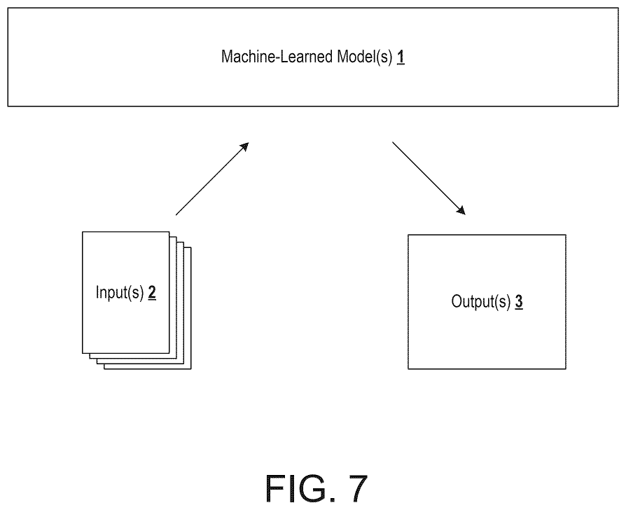

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of a sequence processing model used for message generation. Although various features, variations, and implementations described below are described with respect to machine-learned model(s) 1, it is to be understood that such features, variations, and implementations are to be understood as described with respect to the sequence processing model used for message generation, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single, or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feed-forward or fully-connected layers).

Machine-learned model(s) 1 can employ a mixture-of-experts structure. See, e.g., Zhou et al., Mixture-of-Experts with Expert Choice Routing, arXiv: 2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feed-forward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

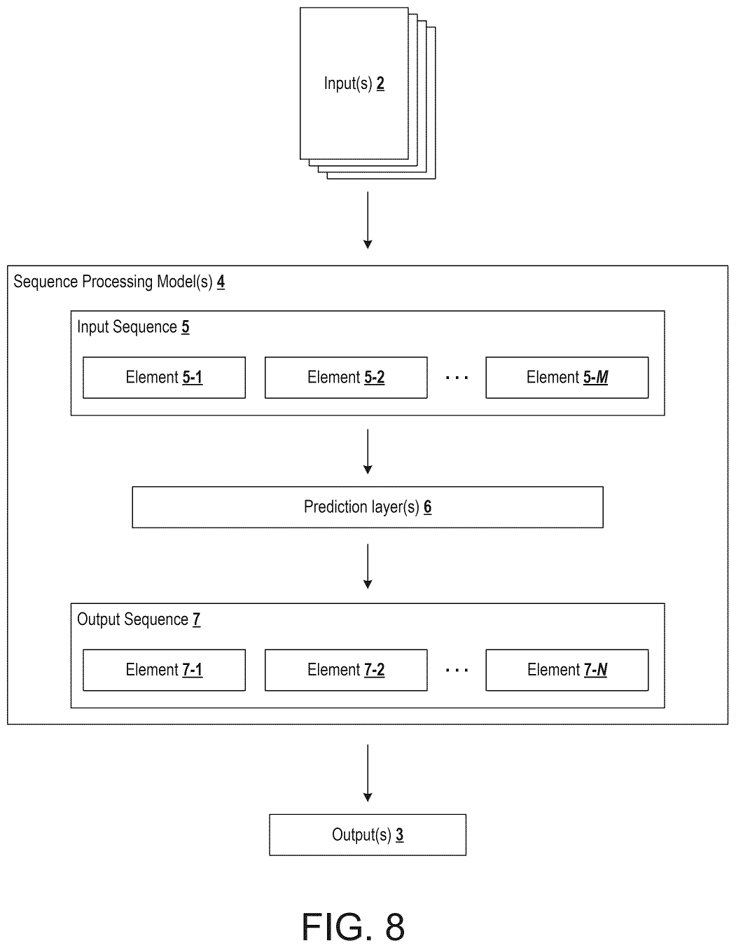

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv: 2010.11929v2 (Jun. 3, 2021), audio domains, see, e.g., Agostinelli et al., MusicLM: Generating Music From Text, arXiv: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both. In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

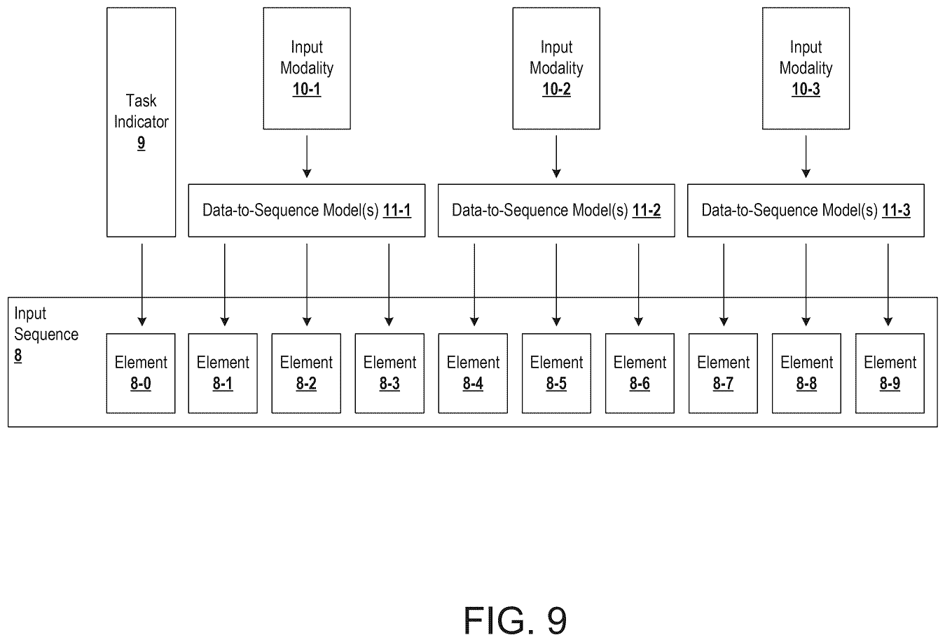

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

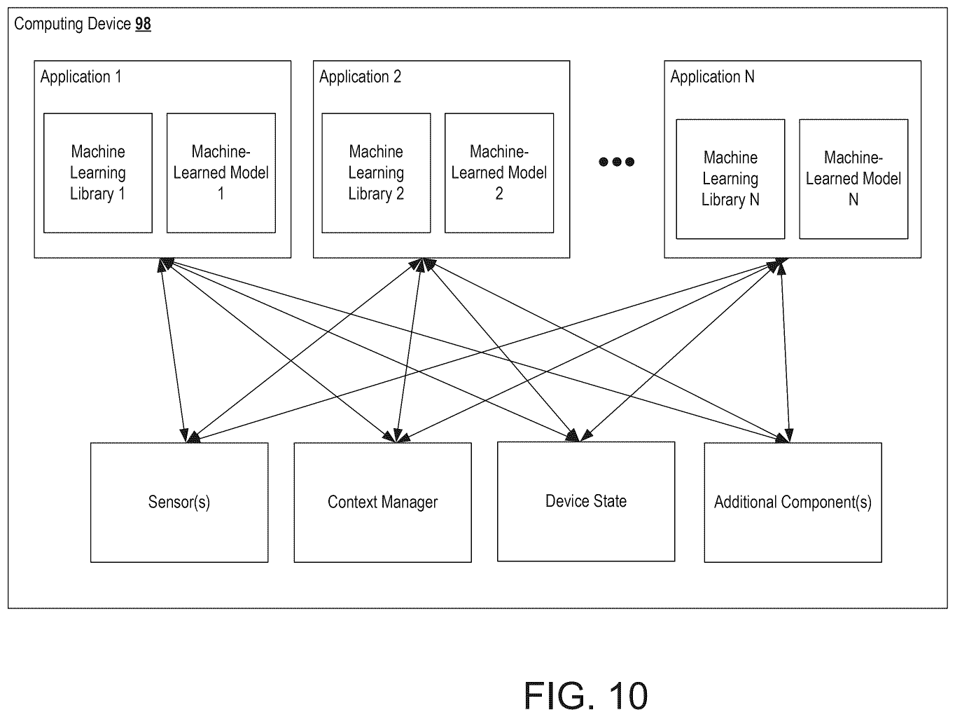

FIG. 10 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 10, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

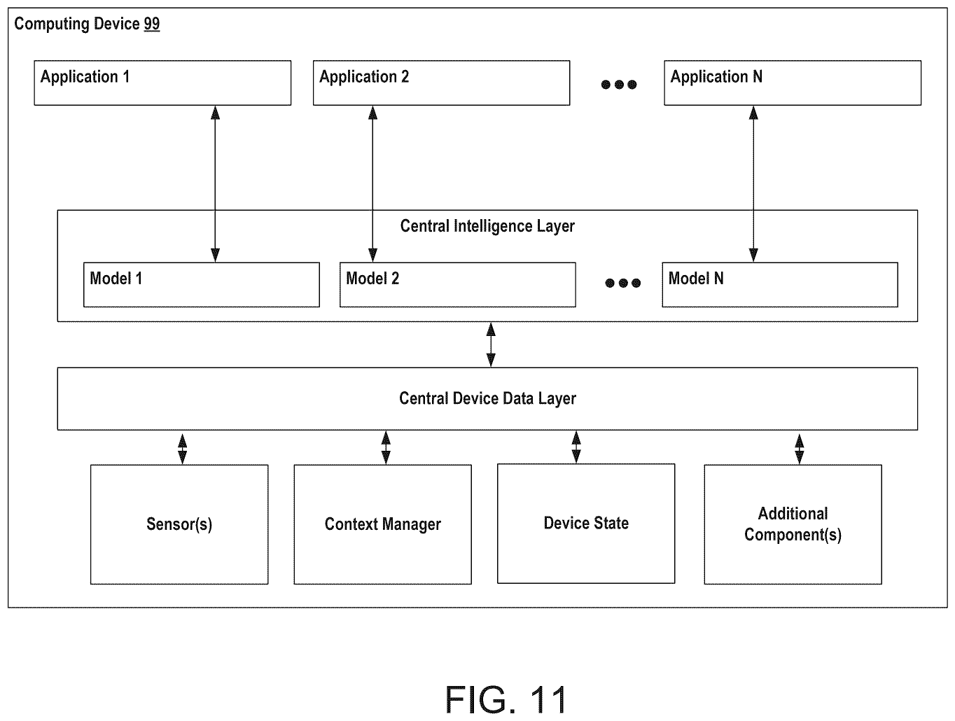

FIG. 11 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 11, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 11, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for reducing computer system downtime, the method comprising:
receiving, by a computing system as part of an execution of a computer application, application status data describing an error that occurred during the execution of the computer application;
generating, by the computing system, a model input using the application status data;
providing, by the computing system, the model input to a machine-learned model;
receiving, by the computing system, a model output from the machine-learned model, the model output including a natural language message to a user to respond to the error described by the application status data; and
displaying, by the computing system, the model output to the user.

2. The computer-implemented method of claim 1, wherein the application status data includes an error code.

3. The computer-implemented method of claim 2, wherein the error code is a fixed value predetermined by a creator of the computer application at a time in which the computer application was created.

4. The computer-implemented method of claim 1, wherein the application status data describes a type of error and a context of the error.

5. The computer-implemented method of claim 1, wherein the machine-learned model is a generative model.

6. The computer-implemented method of claim 1, wherein the model input is a prompt.

7. The computer-implemented method of claim 6, wherein the prompt includes the application status data and contextual data associated with operation of the computing system.

8. The computer-implemented method of claim 7, wherein the contextual data includes user profile data describing a current level of understanding associated with the user.

9. The computer-implemented method of claim 8, wherein the contextual data includes information describing a current operational status of one or more components of the computing system executing the computer application.

10. The computer-implemented method of claim 1, wherein generating, by the computing system, the model input using the error data further comprises:
determining, by the computing system and based on the application status data, one or more sources of data associated with the error that occurred during the execution of the computer application;
accessing, by the computing system, contextual data from the one or more determined sources of data; and
adding, by the computing system, the contextual data to the model input.

11. The computer-implemented method of claim 1, wherein the machine-learned model is a sequence processing model.

12. A computing device, the computing device comprising:
one or more processors; and
one or more non-transitory computer-readable media that collectively store instructions that, when executed by the one or more processors, cause the computing system to perform operations, the operations comprising.
receiving application status data describing an error that occurred during the execution of the computer application;
generating a model input using the application status data;
providing the model input to a machine-learned model;
receiving a model output from the machine-learned model, the model output including a natural language message to a user to respond to the error described by the application status data; and
displaying the model output to the user.

13. The computing device of claim 12, wherein the application status data includes an error code.

14. The computing device of claim 13, wherein the error code is a fixed value predetermined by a creator of the computer application at a time in which the computer application was created.

15. The computing device of claim 12, wherein the application status data describes a type of error and a context of the error.

16. The computing device of claim 12, wherein the machine-learned model is a generative model.

17. A non-transitory computer-readable medium storing instructions that, when executed by one or more computing devices, cause the one or more computing devices to perform operations, the operations comprising.
receiving application status data describing an error that occurred during the execution of the computer application;
generating a model input using the application status data;
providing the model input to a machine-learned model;
receiving a model output from the machine-learned model, the model output including a natural language message to a user to respond to the error described by the application status data; and
displaying the model output to the user.

18. The non-transitory computer-readable medium of claim 17, wherein the application status data includes an error code.

19. The non-transitory computer-readable medium of claim 18, wherein the error code is a fixed value predetermined by a creator of the computer application at a time in which the computer application was created.

20. The non-transitory computer-readable medium of claim 17, wherein the application status data describes a type of error and a context of the error.
